(19) United States
(12) Patent Application Publication
(10) Pub. No.: US 2016/0077345 A1
(43) Pub. Date: Mar. 17, 2016

(54) Eliminating Binocular Rivalry in Monocular Displays

(71) Applicants: Michael Bohan, Carnation, WA (US); John Morris, Bellevue, WA (US); Yuenkeen Cheong, Sammamish, WA (US); Errol M. Tazbaz, Bellevue, WA (US); Rod G. Fleck, Bellevue, WA (US)

(72) Inventors: Michael Bohan, Carnation, WA (US); John Morris, Bellevue, WA (US); Yuenkeen Cheong, Sammamish, WA (US); Errol M. Tazbaz, Bellevue, WA (US); Rod G. Fleck, Bellevue, WA (US)

(21) Appl. No.: 14/489,370

(22) Filed: Sep. 17, 2014

(51) Int. Cl. G02B 27/02; G02B 5/23; G02B 26/02; G02C 7/16; G02C 7/10

(52) U.S. Cl. CPC G02B 27/022; G02C 7/16; G02C 7/101; G02B 26/02; G02B 5/23

(57) ABSTRACT

A monocular display device of a head mounted monocular display is adjustably positioned in front of a display eye of a user. The monocular display device displays information in a first field of view of the display eye. An occluding device is adjustably positioned in front of a non-display eye of the user. The occluding device blocks a second field of view of the non-display eye, the blocking being regulated to block at least a part of the second field of view that corresponds to the first field of view containing the displayed information.

### BACKGROUND

In general, binocular rivalry occurs when one image is presented to one eye and a different image is presented to the other eye. For example, binocular rivalry occurs in monocular head mounted displays (MHMDs) when an image is projected in front of the display eye of a user, while the non-display eye of the user sees the world that lies behind the image projected by the display. Some existing systems introduce an element into the field of view of the non-display eye that completely blocks the entire field of view of the non-display eye, thus reducing the user to a single eye view. Some other existing systems regard the image projected via the display as the “attention area” and expect the user to ignore the “non-attention area.” In some other existing systems, optokinetic nystagmus is used to reduce the binocular rivalry by producing a stimulus synchronized with the occurrence of the binocular rivalry. Some other existing methods resort to reduction of the brightness of the scene visible to the non-display eye by limiting the light incident on the non-display eye. However, none of these existing systems eliminates binocular rivalry without impeding normal vision. As such, binocular rivalry continues to be one of the biggest barriers to the comfortable use of monocular head mounted displays.

### SUMMARY

Examples of the disclosure eliminate binocular rivalry in monocular head mounted displays (MHMDs). A monocular display device of an MHMD is adjustably positioned in front of a display eye of a user. The monocular display device displays information in a first field of view of the display eye. An occluding device is adjustably positioned in front of a non-display eye of the user. The occluding device blocks a second field of view of the non-display eye, with the blocking being regulated to block at least a part of the second field of view that corresponds to the first field of view. Suitably positioning and/or adjusting the properties of the occluding device allows the user to view the information projected by the monocular display device with the display eye while preventing the non-display eye from seeing the world that lies behind the projected image of the display in the first field of view of the display eye.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary schematic diagram illustrating an observer with a different field of view for each eye.

FIG. 2 is an exemplary schematic diagram illustrating a common field of view as seen by both eyes and different fields of view as seen by the left and the right eye.

FIG. 3 is an exemplary schematic diagram illustrating a common field of view as seen by both eyes when both eyes are focused on the same object.

FIG. 4 is an exemplary schematic diagram illustrating a user using an MHMD.

FIG. 5 is an exemplary schematic diagram illustrating a user using an MHMD with an occluder suitably positioned to avoid binocular rivalry.

FIG. 6 is an exemplary block schematic diagram illustrating lines of sights of both the eyes, while the image projector is adjusted as to be transparent (e.g., see-through) and is not projecting any image in the line of sight of the right eye.

FIG. 7 is an exemplary block schematic diagram illustrating lines of sights of both the eyes, while the image projector is not projecting any image and is placed away from the line of sight of the right eye.

FIG. 8 is an exemplary block schematic diagram illustrating the use of an MHMD when the image projector is projecting an image (or other information) and an occluder is blocking that line of sight of the left eye that corresponds to the line of sight of the right eye to which the image is being projected.

FIG. 9 is an exemplary block schematic diagram illustrating the lines of sights of both the eyes, while the image projector is not projecting any image, and the image projector as well as the occluder are configured to be transparent and in the respective line of sight of the right and the left eye.

FIG. 10 is an exemplary block schematic diagram illustrating the operation of the MHMD, while the display projector and the occluder are in the respective fields of view of the right and the left eye, where the field of view of the left eye that corresponds to the field of view of the right eye is blocked by the occluder.

FIG. 11 is an exemplary schematic diagram illustrating an electrical occluder associated with the MHMD.

FIG. 12 is an exemplary schematic diagram illustrating a variable transmittance occluder.

FIG. 13 is an exemplary schematic diagram illustrating an occluder clipped on a nose bridge of the user.

FIG. 14 is an exemplary flowchart illustrating the operations performed by the MHMD to occlude the field of view on the non-display eye of a user when the MHMD is in operation.

FIG. 15 is an exemplary block schematic diagram illustrating a computing device embedded within or otherwise associated with the MHMD.

Corresponding reference characters indicate corresponding parts throughout the drawings.

### DETAILED DESCRIPTION

Referring to the figures, examples of the disclosure eliminate binocular rivalry in monocular head mounted displays (MHMDs) 418. Some examples prevent a non-display eye of a user from seeing the world that lies behind an image projected onto a display eye of the user. The image occupies a first field of view of the display eye (e.g., a right eye field of view 104). Aspects of the disclosure are operable with any form of image. For example, the image projected, using an image projector, may include a static image, a dynamic image such as video, a synthetic image produced via animation, any document, file, text, and/or any other information that may be perceived by a human eye. In some examples, an occluder 502 is adjustably positioned in front of the non-display eye of the user to limit a second field of view of the non-display eye, where the second field of view corresponds to the first field of view The correspondence between the second and first fields of view indicates that the second field of view completely overlaps, covers, and/or includes the first field of view to prevent the non-display eye from seeing anything in the first field of view (e.g., a space that would otherwise be visible to the display eye of the user if the user were not using the MHMD 418).

In some examples, adjustable mechanical means are used to limit the field of view of the non-display eye. In some other examples, electrical and/or electronic means are used to adjust the position and/or the transmittance of an occluding element (e.g., occluder 502) to limit the field of view of the non-display eye. In still other examples, properties of the materials used for the occluding element are used to produce a partial or complete occluding of the field of view (e.g., the second field of view) of the non-display eye (e.g., using photochromic glass) that corresponds to the field of view (e.g., the first field of view) containing the projected image.

Aspects of the disclosure limit, to the non-display eye, a real world background view 606 that lies behind an image projector 412, positioned in front of the display eye, of the MHMD 418 while providing a broad view of the environment to the user to enable the user to recognize the environment and navigate around it. Thus, aspects of the disclosure provide a facility that is different from completely hiding the entire field of view of the non-display eye. Aspects of the disclosure provide active immersion and action around the real world while specific information such as text, graphics, and real time parameters (e.g., flight data and parameters) are available to the user via the MHMD 418. For example, a pilot, while maneuvering an airplane, may be provided with information in the projected image such as engine parameters, cross-wind data, air speed, altitude, attitude information, etc. Aspects of the disclosure further operate to avoid motion sickness which might otherwise be felt while using the MHMD in moving vehicles such as aircraft or ships (e.g., where the background view 606 is changing).

Aspects of the disclosure further enable selective blocking of the real world using means for limiting the field of view of the non-display eye and for enabling control over the extent of limiting of the field of view of the non-display eye (e.g., a left eye 406 of a user 402) based on situational demands. Further, aspects of the disclosure enable blocking a user-chosen area in the field of view of the non-display eye to accommodate specific preferences of the user. Aspects of the disclosure maintain a clear view of the world while at the same time improve the clarity of the display as perceived by the user 402.

At least because of the capability of regulating the extent of blocking the field of view of the non-display eye as described herein, various functionalities of the disclosure may be adapted to suit individual preferences and situational aptness for different users. For example, aspects of the disclosure provide a reduced view of the world while also providing a clear view of the display to suit individual tastes, likes, and dislikes. Aspects of the disclosure improve efficiency of the user 402 by preventing conflicting information reaching the eyes that may pose problems to the user 402 in processing the received information and/or acting on it.

By providing the MHMD 418 that eliminates binocular rivalry, aspects of the disclosure provide a device that uses less space, extend user interface (e.g., user interface 1526) functionality, and improve interaction between the user and the MHMD 418. Aspects of the disclosure reduce a user error rate in a given environment while using computing devices that employ an MHMD.

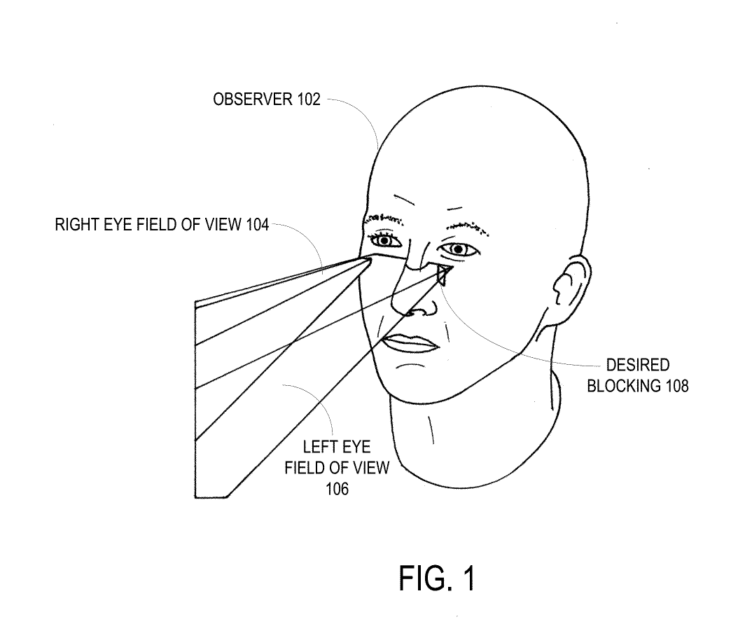

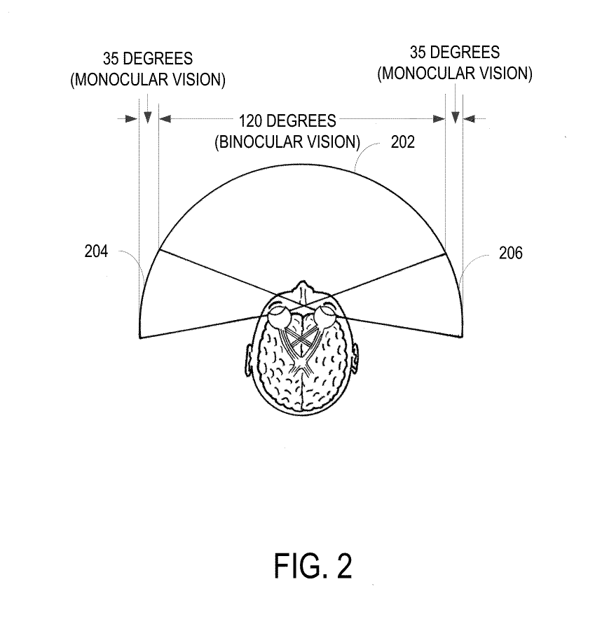

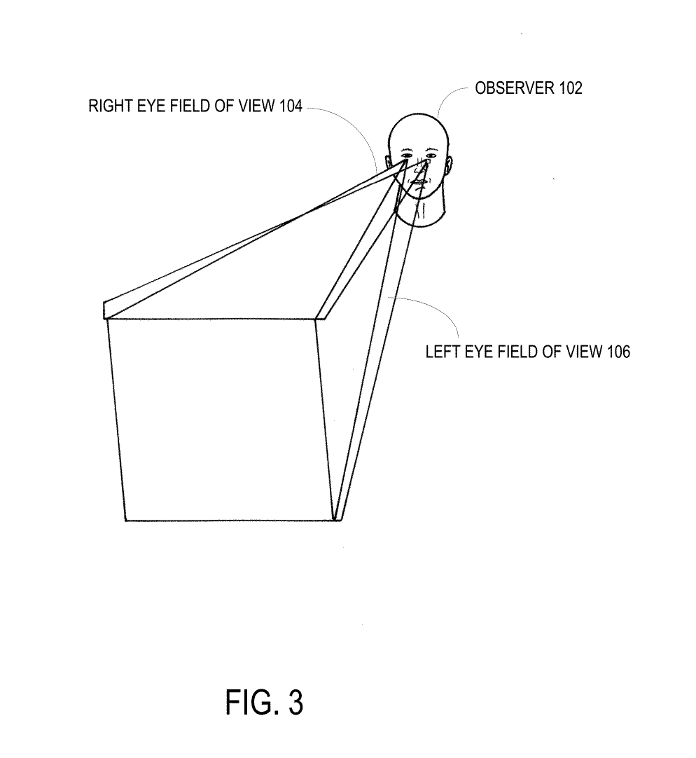

As shown in FIG. 1, a field of view 104 of the right eye of an observer 102, which may include an image projected by an image projector of an MHMD, may be different from the field of view 106 of the left eye. Occasionally, brief and unstable composites of two images, one in the field of view 106 of the left eye and the other in the field of view 104 of the right eye, may be seen. Human beings have a horizontal field of view of approximately 190 degrees with two eyes, approximately 120 degrees of which makes up the binocular vision as shown at 202 of FIG. 2 while the monocular vision of each eye is approximately 35 degrees as shown at 204 and 206. In some situations, such as when looking straight ahead, the fields of view of both the right eye and the left eye are almost the same as shown, for example, in FIG. 3.

As next described, to suppress binocular rivalry, aspects of the disclosure block a portion of the field of view of one eye, as shown in front of the left eye at 108 in FIG. 1.

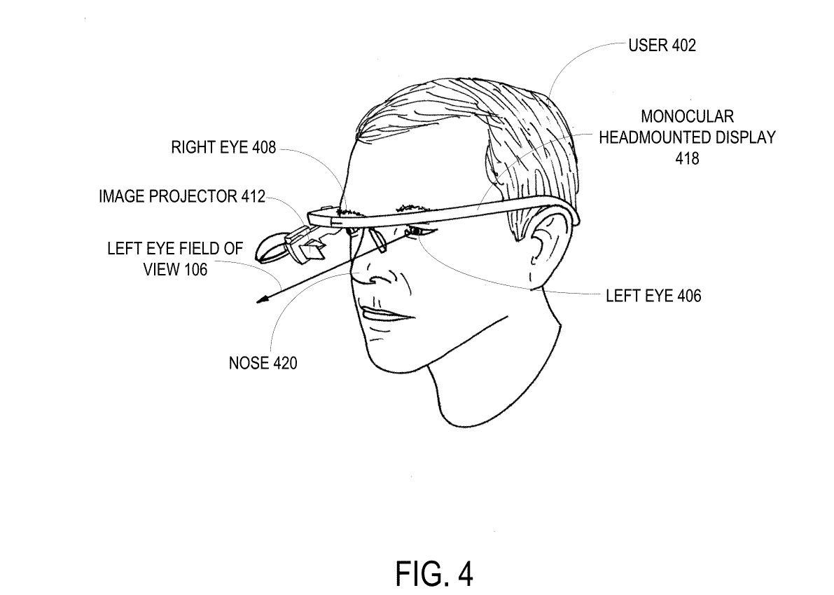

Referring to FIG. 4, an exemplary diagram graphically illustrates an MHMD 418 being used by the user 402. The MHMD 418 has an image projector 412 that project at least one projected image to the display eye of the user (e.g., right eye 408). The projected image includes any information. In this example, the left eye 406 is the non-display eye. The exemplary FIG. 4 also depicts a field of view 106 of the non-display eye. FIG. 4 shows nose 420 of the user that may be used as reference in some examples of the disclosure.

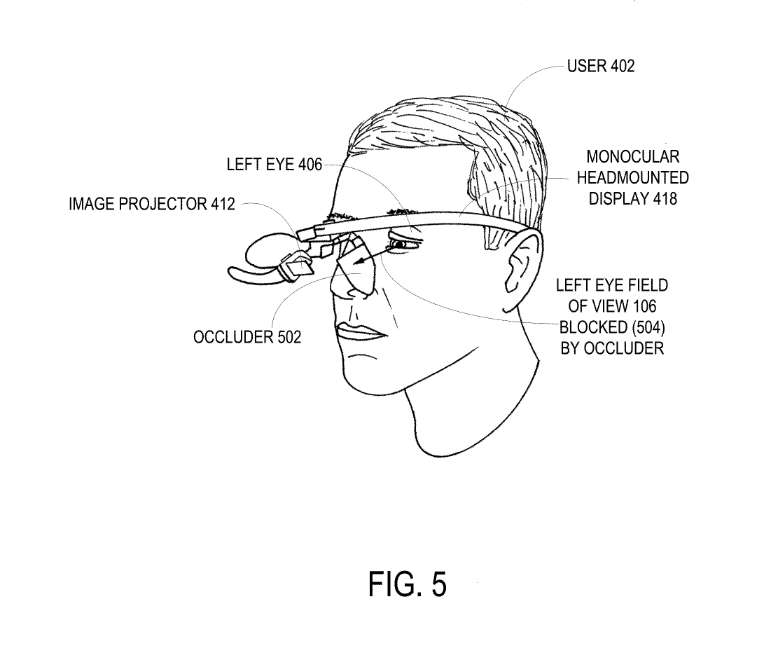

Referring next to FIG. 5, an exemplary diagram graphically illustrates the MHMD 418 being used by the user 402 together with an adjustable occluder 502 being placed close to the nose 420 of the user 402. In the example of FIG. 5, the MHMD 418 has a built-in computing device (not shown) or a computing device associated with the MHMD 418 (not shown). The MHMD 418, together with the computing device associated with it, represents a system for presenting information to the user 402 while eliminating binocular rivalry and enabling the user 402 to naturally navigate and interact with their environment without receiving confusing stimuli. The occluder 502 is positioned, configured, and/or adjusted such that the occluder 502 blocks that the field of view of the non-display eye corresponding to the field of view of the right eye 408 containing the projected image as shown at 504. In the example of FIG. 5, the right eye 408 is the display eye. In some examples, the occluder 502 is located near the mid-sagittal plane of the user's face and limits the view of the non-display eye. For example, the occluder 502 may include a fin, a flap, a blade, a flipper, a vane, a sheet or a tab or the like, that is attachably connected to the MHMD 418. However, those skilled in the art will note that the occluder 502 may include any blocking means.

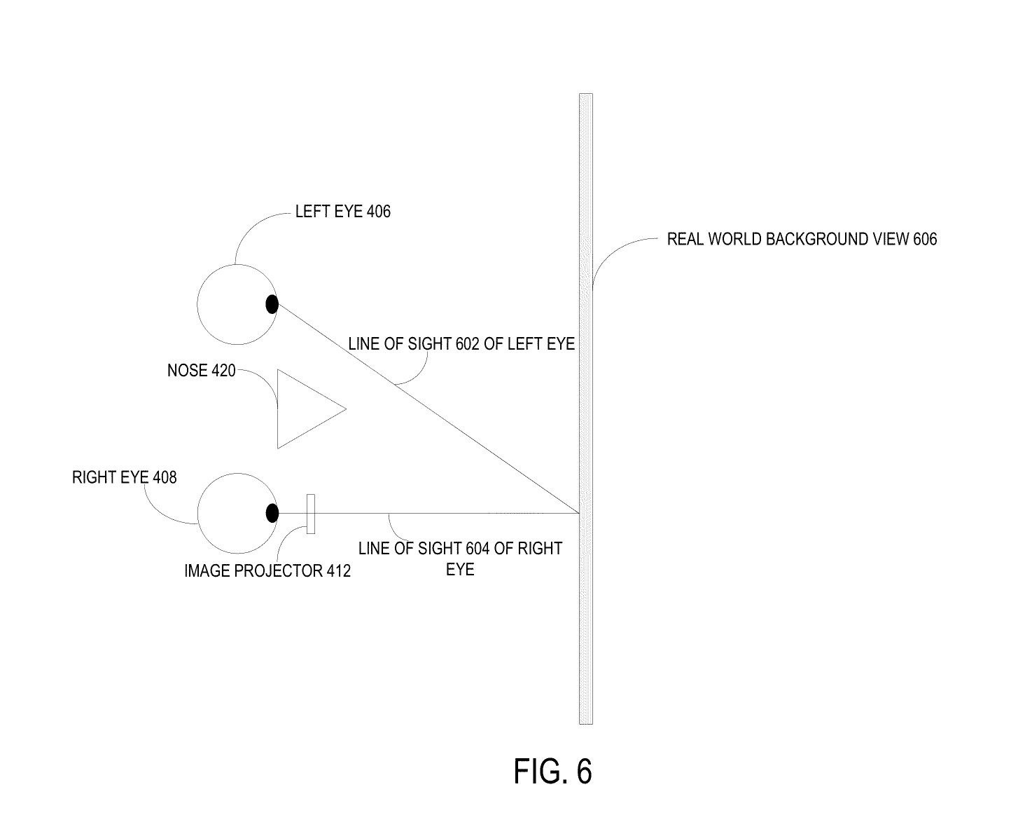

Referring now to FIG. 6, an exemplary block diagram graphically illustrates usage of the MHMD 418 (not shown) when the image projector 412 is not projecting any image and/or information onto the display eye, for example, right eye 408 of the user 402. In the example of FIG. 6, the left eye 406 has a line of sight 602, while the right eye 408 has a line of sight 604. In this example, a transmittance of the image projector 412 is adjusted such that the line of sight 604 of the right eye is clear to see a real world background view 606. The transmittance may be adjusted, for example, by automatically applying a control signal, by the user 402 giving a command, or by other means such as by varying the reflective and/or transmissive properties of the materials used for the image projector 412 based on an amount of ambient light.

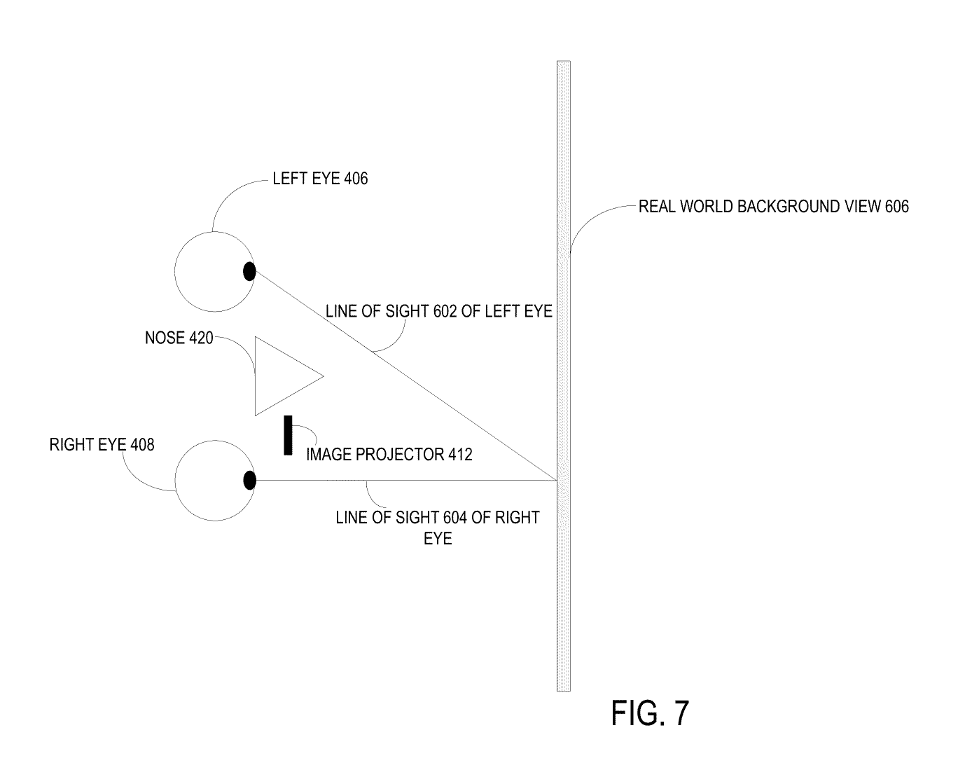

Referring next to FIG. 7, another exemplary block diagram graphically illustrates usage of the MHMD 418 (not shown) when the image projector 412 is not projecting any image and/or information onto the display eye, for example, right eye 408 of the user 402. In the example of FIG. 7, the left eye 406 has a line of sight 602, while the right eye 408 has a line of sight 604. The image projector 412 may be opaque or partially opaque and positioned such that the line of sight 604 of the right eye 408 is not blocked. Such positioning of the image projector enables the right eye 408 to see the real world background view 606, while at the same time the left eye 406 is also free to see the real world background view 606.

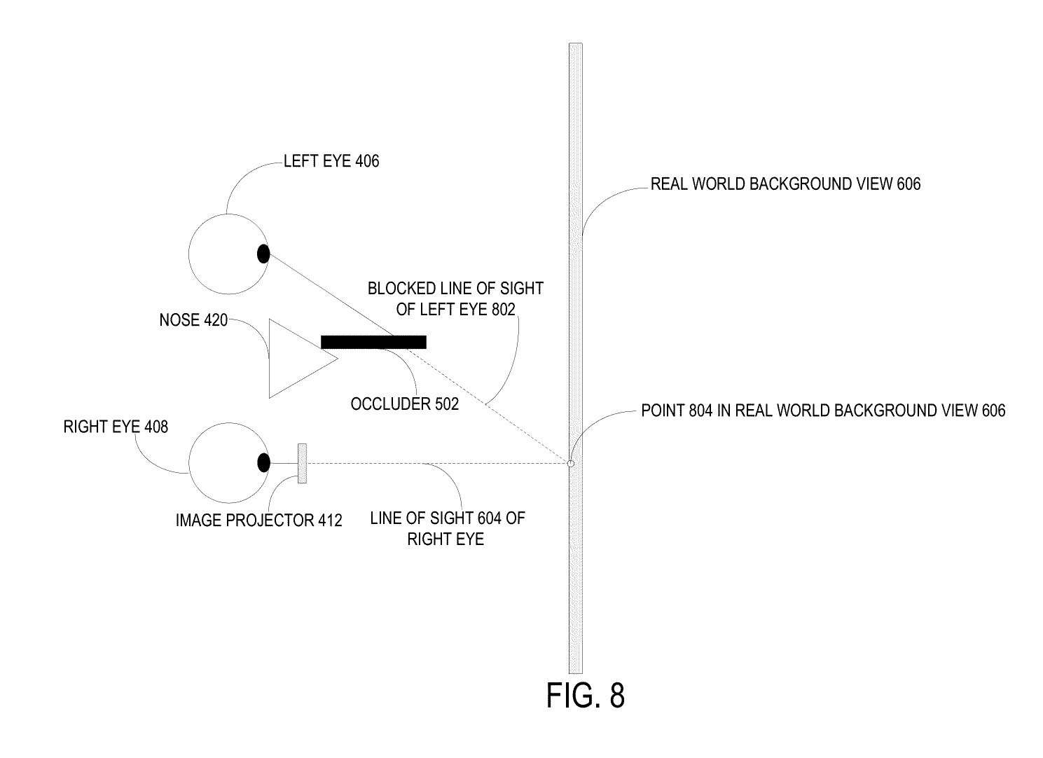

In FIG. 8, the image projector 412 of the MHMD 418 (not shown) projects an image and/or information onto the display eye, for example, right eye 408 of the user 402. In this example, the occluder 502 is positioned in the line of sight 602 of the left eye 406. The occluder 502 may be opaque be, and/or adjusted to be, opaque or partially opaque to block and/or blur the line of sight 602 of the left eye 406 as shown at 802. The image projector 412 may project an image in front of the right eye 408 of the user 402 such that it appears to be originating from a point 804 in the real world background view 606. For clarity, the actual image projected by image projector 412 is not shown in FIG. 8. Thus, while the point 804 is not visible to the left eye 406 because of the occluder 502 being positioned and/or adjusted to block/blur the line of sight 602 of the left eye 406, the rest of the real world background view 606 is visible to the left eye 406. This eliminates the binocular rivalry while the view as perceived by both the eyes is such that the projected image (e.g., from the image projector 412) is seen together with the real world background view 606 mimicking a scene as if the projected image is present within the real world background view 606 at point 804, thus enabling the user 402 to move around their environment and perform any action without any disorientation or confusion. In the example of FIG. 8, the image projector may be translucent or opaque or therebetween, or may be adjusted to be translucent or opaque or therebetween, in accordance with situational considerations or user preferences or both. Similarly, while the occluder 502 is shown as opaque, it may be translucent or opaque or therebetween, or may be adjusted to be translucent or opaque or therebetween, in accordance with situational considerations or user preferences or both. The occluder 502, in the example of FIG. 8, is shown at a location that is close to the nose 420 of the user 402. Such a location appears to the user as a natural extension of the nose 420 and is least intruding and obtrusive. However, other locations may also be suitable and may be used to suit the preferences and likes of the user 402.

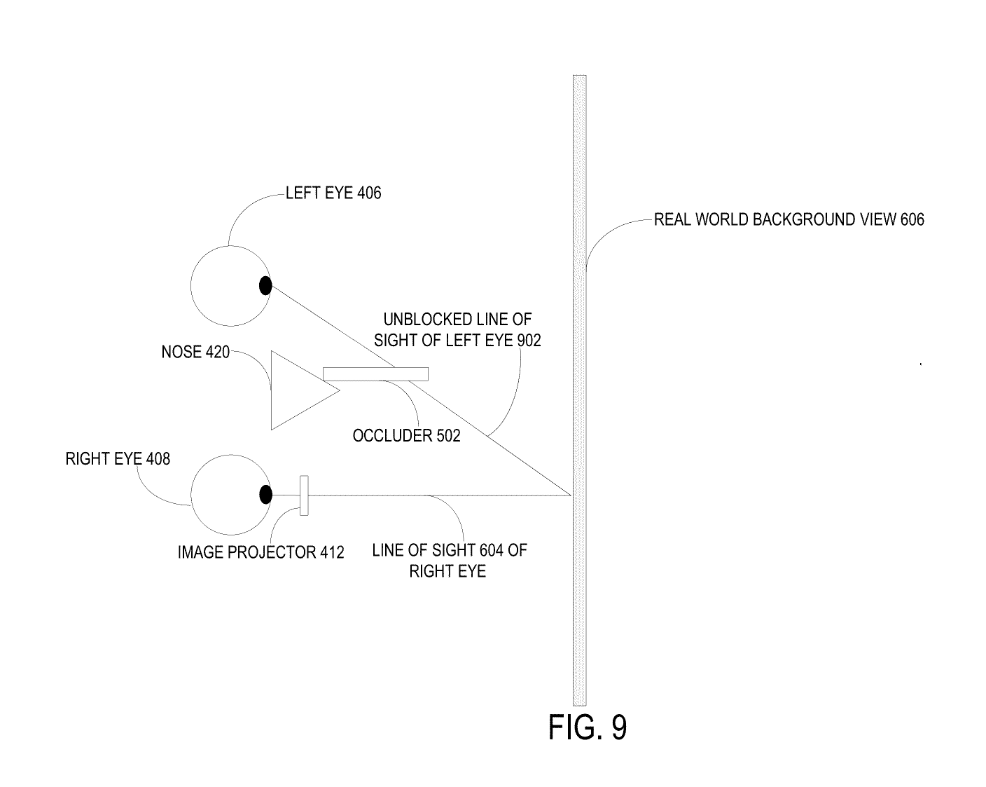

In FIG. 9, while the positioning of the occluder 502 and the image projector 412 are not changed, their transmissive and/or reflective properties are suitably adjusted, for example, by application of control signals. In this case, there is no blocking or blurring of the line of sight 602 of the left eye 406 as shown at 902. Similarly, the line of sight 604 of the right is also unimpeded. Accordingly, both eyes function as if the user has no MHMD 418 and the real world background view 606 is visible to both the eyes as would be the case when the user has no MHMD 418. This example does not necessitate removing the MHMD 418, when the user 402 temporarily does not want to use the MHMD 418.

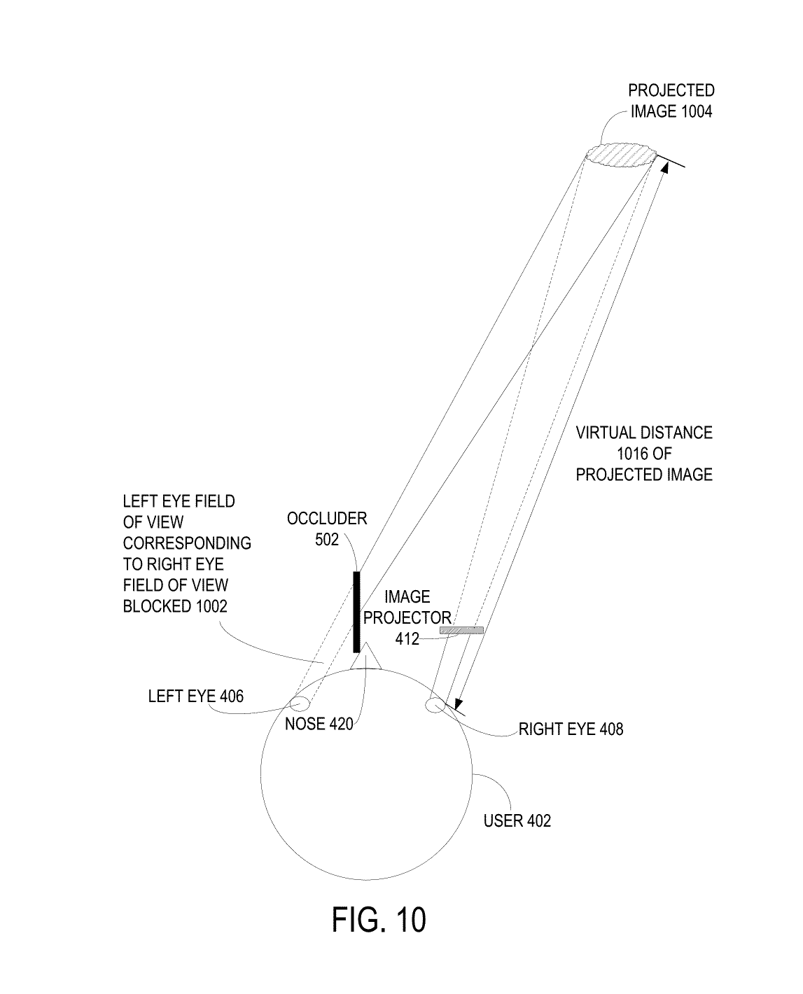

FIG. 10 illustrates an example of the usage of the MHMD 418 in which the distance of the projected image 1004, as perceived by the display eye (e.g., right eye 408) may be varied based on control inputs. The image projector 412 may be projecting the image 1004 to the right eye 408, while the occluder 502 has been adjusted and/or positioned to block and/or blur a field of view of the left eye 406 that corresponds to the right eye field of view onto which the projected image 1004 is being projected as shown at 1002. The projected image 1004 appears to the right eye 408 to be emanating from a distance 1016, while the distance 1016 may have a variable value (e.g., two meters). The ability to vary the apparent distance and location of the projected image 1004 provides a means for integrating the projected image with the environments of the user 402 (e.g., in a virtual reality gaming application). For example, if an avatar of the user 402 is shown fighting a zombie, shown as a projected image 1004, the movements of the projected image 1004 in the space of the environment simulate the zombie moving and fighting with the avatar of the user that mimics a real world scenario.

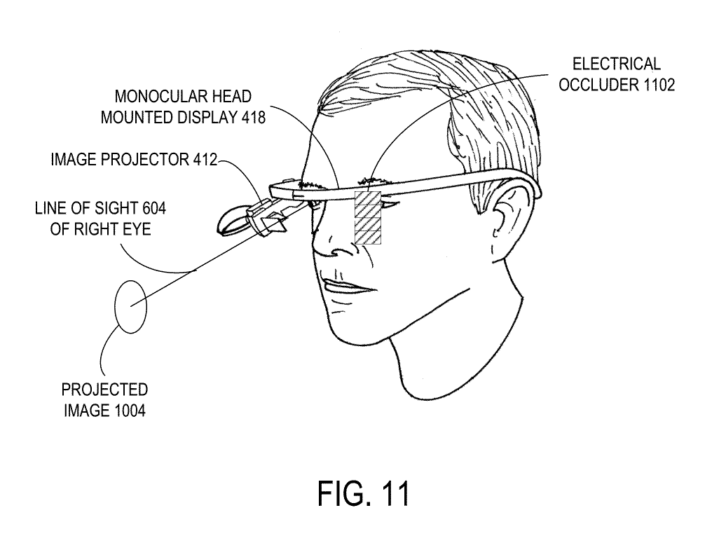

FIG. 11 illustrates usage of an exemplary electrical occluder 1102. The electrical occluder 1102 is attached to the MHMD 418 and may comprise rotatable vanes that rotate about respective horizontal axes in respective vertical planes in response to, for example, application of a control signal. Thus, in response to the application of suitable control signals, a line of sight of the non-display eye that corresponds to the line of sight 604 of the display eye may be blocked. If no image is being projected onto the display eye, either absence of a control signal or presence of a different control signal may cause the vanes to assume an orientation that does not cause blocking of the line of sight of the non-display eye.

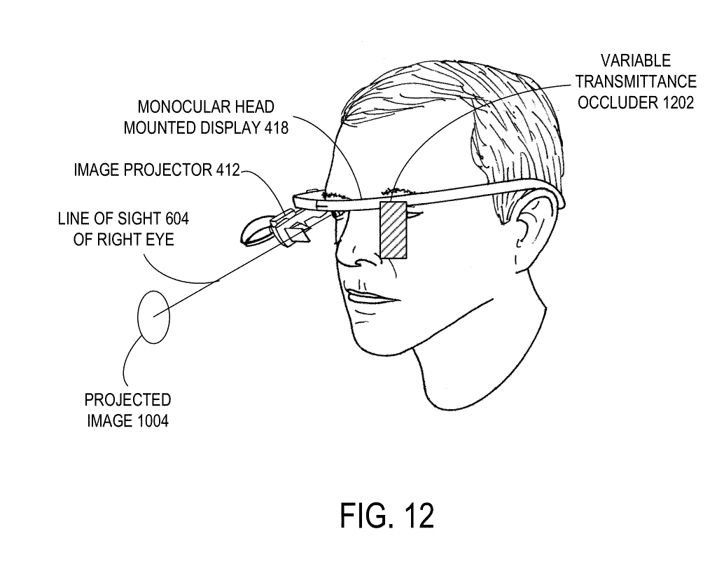

FIG. 12 illustrates usage of another exemplary electrical occluder (e.g., a variable transmittance occluder 1202). In the example of FIG. 12, the variable transmittance occluder 1202 is attached to the MHMD 418 and comprises a structure that may change its transmittance in response to application of an electrical signal or field. For example, the variable transmittance occluder 1202 may have a liquid crystal structure and may selectively transmit or block light incident on the liquid crystal (LC) structure based on an application of voltage. As another example, the structure of the variable transmittance occluder 1202 may comprise material that exhibit electrochromism and may change their level of opacity and/or change their color based on the application of electrical field thus varying their transmittance. As a further example, the variable transmittance occluder 1202 may have a multi-layer structure comprising any combination of photochromic material, electrochromic material, and polymer dispersed liquid crystal material that may provide a suitable dimming of ambient light when the image projector 412 is not active and block/blur the line of sight of the non-display eye when the image projector 412 is active.

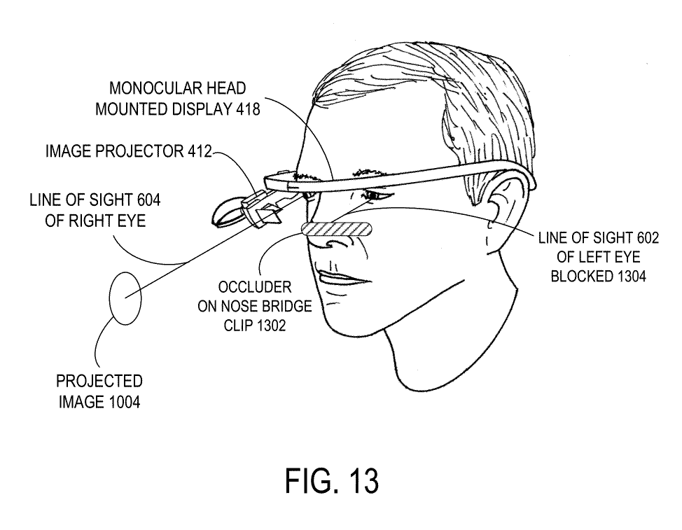

In some examples, occluding devices may be independent of the MHMD 418. FIG. 13 illustrates a nose bridge clip 1302 that may be clipped onto a nose bridge of the user 402. The nose bridge clip 1302 is either opaque or its opacity may be adjusted based on control signals that may be transmitted to the nose bridge clip 1302 wirelessly or otherwise. Once opaque, the nose bridge clip 1302 blocks that line of sight of the non-display eye (e.g., left eye 406) which is directed to the projected image 1004 as shown at 1304. Hence, the nose bridge clip 1302 prevents the non-display eye from seeing the real world that lies directly behind the projected image 1004. In this example, the line of sight 604 is unimpeded and perceives the projected image 1004 as originating at a point in space in the real world background view 606 that is blocked from the line of sight 602 of the left eye 406.

In some examples, an occluding device, that is independent of the MHMD 418, may be suitably positioned in front of the non-display eye of the user 402 to adjustably block a field of view of the non-display eye (e.g., a second field of view) that corresponds to a field of view of the display eye onto which an image and/or other information is being projected by the image projector 412 (e.g., the first field of view). For example, the occluding device may be a hand-held device that is suitably positioned near a mid-sagittal plane of the face of the user 402 to block the second field of view. In another example, the independent occluding device may comprise a physical component, made of suitable material (such as plastic or multi-layer structures) and worn on the body of the user, whose position is adjustable with respect to the nose 420 of the user 402, and that may be suitably positioned to block the second field of view.

In some examples, the image projected onto the display eye of the user may be adjusted to be displayed outside the field of view of the non-display eye of the user 402. In these examples, there is no need for the occluder 502. For example, when the projected image (e.g., projected image 1004) lies within a field of view of the non-display eye, the image may be re-directed so as to fall outside the field of view of the non-display eye and hence outside the binocular vision 202. For example, the projected image may be positioned such that it is hidden behind the nose 420 of the user 402. In some example, the image projector 412 and/or the MHMD 418 may be re-positioned so that the projected image lies outside the field of vision of the non-display eye of the user 402. In one example, the re-direction of the displayed image may be done automatically upon detecting that the image is occupying a field of view that is common, or overlaps, with the field of view of the non-display eye. In another example, the re-direction of the displayed image may be done manually, for example by adjusting a position and/or orientation of the image projector 412 and/or the MHMD 418. In some examples of re-directing the location of the projected image (e.g., projected image 1004), the re-directed image falls within the monocular vision of the user's eye (e.g., within a cone of the cones illustrated at 204 and 206 of FIG. 2).

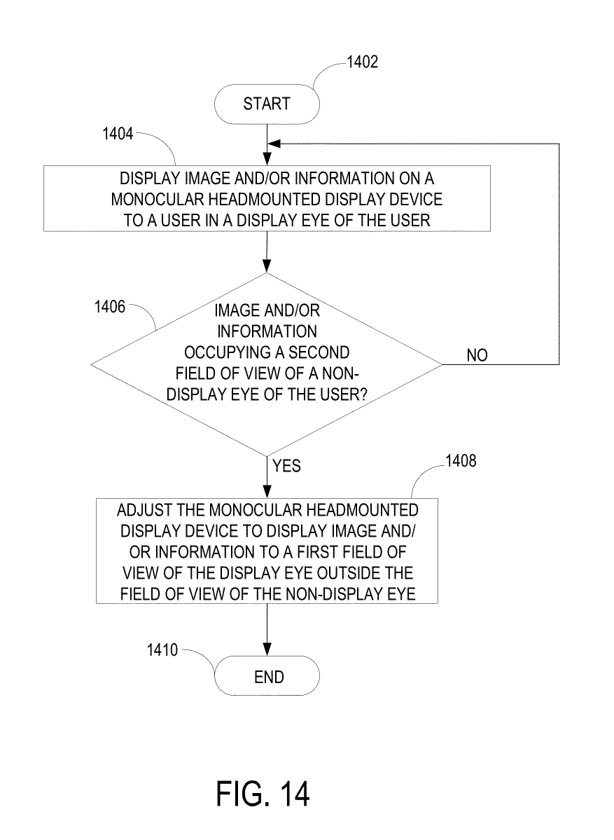

Referring now to FIG. 14, an exemplary flowchart illustrates the operation of an MHMD device in one example. At 1402, the operations of the MHMD device start. At 1404, an image and/or other information is displayed onto a display eye of a user. At 1406, it is checked whether the displayed image is occupying at least a portion of the field of view (e.g., the second field of view) of a non-display eye of the user. If it is determined that the displayed image is occupying the second field of view of the non-display eye of the user, then at 1408, the MHMD device is adjusted to display the image in a first field of view of the display eye of the user, the first field of view of the display eye being outside any field of view of the non-display eye. In some examples, the adjustment of the MHMD device may comprise repositioning the MHMD device and/or an image projector associated with the MHMD device such that the projected image falls outside the region of binocular vision of both the eyes and falls within the monocular vision region of the display eye. At 1410, the operations of the MHMD device associated with the adjustment of the projected image end.

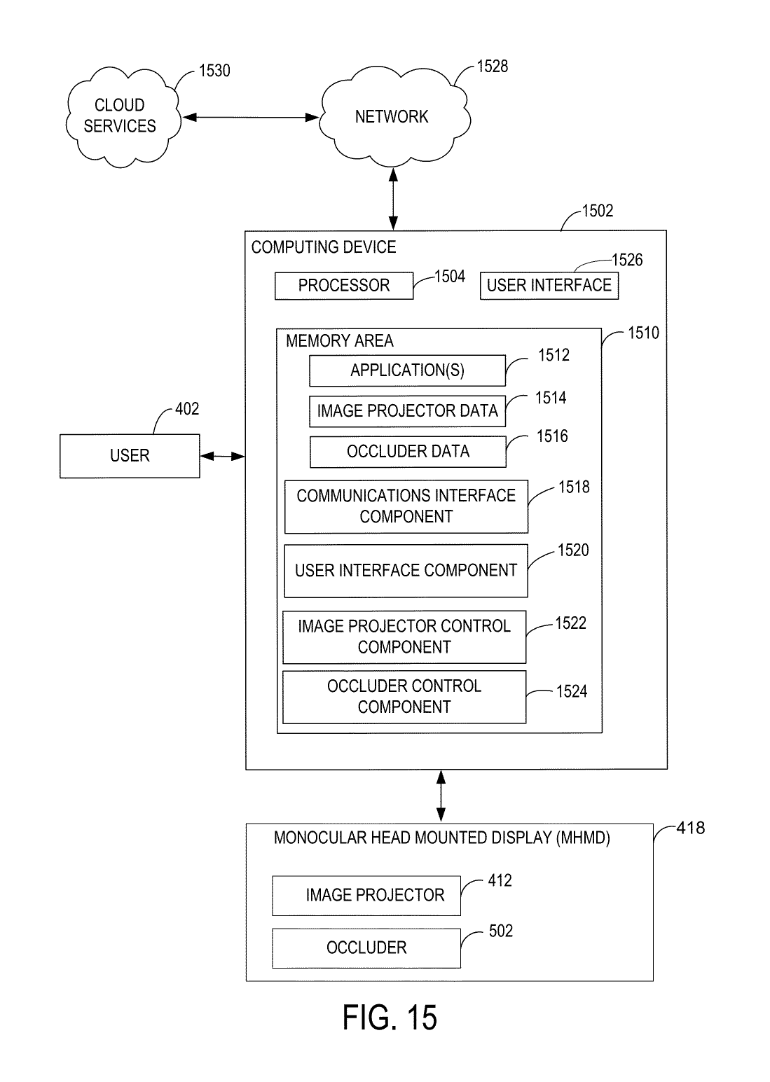

In one example, the MHMD 418 has a computing device built in to MHMD 418 or has at least one computing device associated with it (e.g., a computing device 1502) as schematically illustrated in FIG. 15. FIG. 15 shows the MHMD 418 of the user 402 in communication with the computing device 1502 to perform various functionalities described herein. The computing device 1502 may be embedded within the MHMD 418 or otherwise in communication with the MHMD 418 via, for example, a wireless network such as a Wi-Fi, BLUETOOTH brand communication or a cellular network (not shown). The computing device 1502 represents any device executing instructions (e.g., as application programs, operating system functionality, or both) to implement the operations and functionality associated with the computing device 1502. The computing device 1502 may include a mobile computing device or any other portable device. In some examples, the computing device 1502 includes a mobile telephone, laptop, tablet, computing pad, netbook, gaming device, and/or portable media player. Additionally, the computing device 1502 may represent a group of processing units or other computing devices.

In some examples, the computing device has at least one processor 1504, a memory area 1510, and at least one user interface 1526. The processor 1504 includes any quantity of processing units, and is programmed to execute computer-executable instructions for implementing aspects of the disclosure. The instructions may be performed by the processor 1504 or by multiple processors within the computing device 1502, or performed by a processor external to the computing device 1502. In some examples, the processor is programmed to execute instructions such as those illustrated in the figures (e.g., FIG. 14).

In some examples, the processor 1504 represents an implementation of analog techniques to perform the operations described herein. For example, the operations may be performed by an analog computing device and/or a digital computing device.

The computing device 1502 further has one or more computer readable media such as the memory area 1510. The memory area 1510 includes any quantity of media associated with or accessible by the computing device 1502. The memory area 1510 may be internal to the computing device 1502 (as shown in FIG. 15), external to the computing device 1502 (not shown), or both (not shown). In some examples, the memory area 1510 includes read-only memory and/or memory wired into an analog computing device.

The memory area stores, among other data, one or more applications 1512. The applications 1512, when executed by the processor 1504, operate to perform functionality on the computing device 1502 and the MHMD 418. Exemplary applications include mail application programs, web browsers, calendar application programs, address book application programs, messaging programs, media applications, location-based services, search programs, and the like. The applications 1512 may communicate with counterpart applications or services such as web services accessible via a network such as network 1528. For example, the applications may represent downloaded client-side applications that correspond to server-side services such as cloud services 1530 executing in a cloud.

The memory area 1510 further stores image projection data 1514 and occluder data 1516 that may be used during the operation of the MHMD 418 and may be dynamically updated. The dynamic updating of image projection data 1514 and occluder data 1516 may include periodic updates or updates during the operation of the MHMD 418 or both. The image projection data 1514 includes the data that is provided to the image projector 412 for display onto the display eye of the user. In some examples, the image projection data 1514 may be supplied by the cloud services 1530. The occluder data 1516 includes, for example, parameter values describing an amount of transparency of the occluder 502, parameter values describing the field of view to occlude, etc.

In some examples, the image projection data 1514 and/or the occluder data 1516 may be stored by the cloud services 1530 and supplied on demand. In another example, the image projection data 1514 and/or the occluder data 1516 may be pushed by the cloud services 1530 to the computing device 1502 and periodically updated. In yet another example, the updates may be supplied by the cloud services 1530 on demand on or without payment. In some other example, the user 402 may download the image projection data 1514 and/or the occluder data 1516 from other web services against payment or otherwise.

The image projection data 1514 and the occluder data 1516 may include data associated with the properties and control parameters of the image projector 412 and the occluder 502, the electrical occluder 1102, and the variable transmittance occluder 1202.

The memory area further stores one or more computer-executable components. Exemplary components include a communications interface component 1518, a user interface component 1520, an image projector control component 1522, and an occluder control component 1524.

In some examples, the communications interface component 1518 includes a network interface card and/or computer-executable instructions (e.g., a driver) for operating a network interface card. Communication between the computing device 1502 and other devices or services such as cloud services 1530 may occur using any protocol or mechanism over any wired or wireless connection such as the network 1528. In some examples, the communications interface is operable with short-range communication technologies such as by using near-field communication (NFC) tags.

The communications interface component 1518, when executed by the processor 1504 of the computing device 1502 causes the processor 1504 to communicate with web services (e.g., the cloud services 1530) via the network 1528.

The user interface component 1520, when executed by the processor 1504 of the computing device 1502, enables communication with the user via the user interface 1526. In some examples, the user interface component 1520 includes a graphics card for displaying data to the user and receiving data from the user. The data displayed and received via the user interface 1526 is an alternative to and/or in addition to the display projected via the image projector 412. The user interface component 1520 may also include computer-executable instructions (e.g., a driver) for operating a graphics card. Further, the user interface component 1520 may include a display (e.g., a touch screen display or natural user interface such as user interface 1526) and/or computer-executable instructions (e.g., a driver) for operating the display, in addition to the display provided by the image projector 412. The user interface component 1520 may also include one or more of the following to provide data to the user or receive data from the user: speakers, a sound card, a camera, a microphone, a vibration motor, one or more accelerometers, one or more gyroscopes, a BLUETOOTH brand communication module, global positioning system (GPS) hardware, and a photoreceptive light sensor. For example, the user may input commands or manipulate data by moving the computing device in a particular way.

The image projector control component 1522, when executed by the processor 1504 of the computing device 1502, causes the processor 1504 to provide images and/or other data to the image projector 412 of the MHMD 418 for display onto the display eye of the user 402. Further, the image projector control component 1522 also provides control signals to the image projector 412 to control the location and properties of the image projector 412. The occluder control component 1524, when executed by the processor 1504 of the computing device 1502, causes the processor 1504 to control the location and properties of the occluder 502 (e.g., transmittance, filter characteristics, color characteristics, opacity, altering a plane of polarization of incoming light, and the like).

### Additional Examples

In some examples, the level of brightness of the image displayed by the image projector 412 may be suitably adjusted based on the ambient light intensity. In other examples, when the image projector 412 is projecting images, the vision of the non-display eye may be selectively blurred to eliminate or at least minimize binocular rivalry. Other regions of the real world background view 606, which are not to be blurred/blocked in some examples, may be visible but the extent of brightness as perceived by the user's eyes may be controlled in response to the ambient light intensity. The amount of light incident on the eyes may be controlled by using the properties of photochromism, electrochromism, and LC structure either individually or by any combination of photochromism, electrochromism, LC structure and control signals.

In some examples, multiple layers of different material may be used for the image projector 412, the occluder 502 and/or the variable transmittance occluder 1202. For example, a photochromic material may be used to control the amount of light received by each eye through the image projector 412 and the occluder 502 and/or the variable transmittance occluder 1202. Additional blocking/blurring layer may be used for the occluder 502 and/or the variable transmittance occluder 1202 to eliminate binocular rivalry. In this example Polymer-Dispersed-Liquid-Crystal (PDLC) material or other material exhibiting similar properties may be used for providing the occluding via dispersion and/or blurring. The PDLC material may be used to control the transparency of the image projector 412 and/or the occluder 502 and/or the variable transmittance occluder 1202 over a very large range beginning from a very low value to reach approximately 90% transparency.

In some examples, polarizing material includes multi-layer material that may be used for all or any of the image projector 412, the occluder 502 and/or the variable transmittance occluder 1202. In such examples, the orientation of the polarizer is adjusted such that the multi-layer material may also provide optimum photochromic properties. Further, other factors such as direction of glare (e.g., to read LC display content clearly) and projection angles into an optical waveguide, that may be used in the image projector 412, are optimized to minimize loss of light and provide effective photochromic dimming of the ambient light.

In another example, an occluding device may be a frame supporting glasses, such that the glass in front of the non-display eye of the user 402 may extend outward and may be positioned in front of the non-display eye of the user 402. The glass may be a photochromic glass whose level of opacity increases when exposed to ambient light (e.g., the real world background view 606) thus limiting the field of view of the non-display eye and impeding the line of sight 602.

In some examples, a combination of materials that exhibit photochromism, electrochromism, and LC structure may be used. In this example, changes in the level of transmissiveness may be used for both the image projector 412 and the variable transmittance occluder 1202. As described herein, in some examples, the image projector 412 is made see-through when the image projector 412 is not projecting any image. In some examples, the level of transmittance of different regions of the image projector 412 and the variable transmittance occluder 1202 may be regulated differently by application of suitable control signals based on the location of the image projector 412, the extent of blocking to be provided to the non-display eye, and all the other regions that are to be made see-through. In some examples, different material and control methods (e.g., electrical, optical or chemical methods or a combination of all the three methods) of regulating the transmissive and/or reflective properties of different regions may be used. In some examples, transmissive and/or reflective properties of different regions that comprise the image projector 412 and the variable transmittance occluder 1202 may be independently regulated using suitable control signals. In some examples, a display zone, that is a part on the image projector 412, may have its brightness determined by the amount of ambient light (e.g., it may function as a photochromic material). In one example, a blocking zone that is a part of the variable transmittance occluder 1202 or the occluder 502 may also use photochromic material but transitions to a blocked/blurred state when the image projector 412 display is active.

Alternatively or in addition to the other examples described herein, examples include any combination of the following:

a monocular display device adjustably positioned in front of a display eye of a user, the monocular display device displaying information in a first field of view of the display eye, and

an occluder adjustably positioned in front of a non-display eye of the user, the occluder blocking a second field of view of the non-display eye, the second field of view corresponding to the first field of view.

the occluder comprising a component attached to a part of the monocular display device, the component being located near a mid-sagittal plane of a face of the user and blocking the second field of view of the non-display eye.

blocking the second field of view comprising limiting the second field of view of the non-display eye.

the occluder component being selected from a group consisting of a fin, a flap, a blade, a flipper, a vane, a sheet, and a tab.

the occluder comprises a nose bridge that extends outward from a nose of the user.

the occluder comprises an attachable frame that is removably attached to the monocular display device.

the occluder comprises an electrical occluder.

a transmittance of the electrical occluder varies in response to application of a control signal.

the electrical occluder comprises liquid crystal material.

the electrical occluder comprises electrochromic material.

the electrical occluder includes a set of slats fitted within a frame, the frame being located near a mid-sagittal plane of a face of the user, the slats being rotatable so as to block or unblock the second field of view of the non-display eye.

the slats automatically rotate to block the second field of view of the non-display eye.

the slats rotate in response to a command given by the user to block the second field of view of the non-display eye.

an apparatus for eliminating binocular rivalry occurring from use of a monocular display device displaying information in a first field of view of a display eye of a user, said apparatus comprising:

an occluder adjustably positioned in front of a non-display eye of the user the occluder blocking a second field of view of the non-display eye, the second field of view corresponding to the first field of view of the display eye.

the occluder comprises a photochromic structure that automatically darkens in high ambient light to limit the second field of view of the non-display eye.

the occluder comprises a hand held device that, when positioned near a mid-sagittal plane of a face of the user, blocks the second field of view of the non-display eye.

the occluder comprises an adjustable component worn on the body of the user that, when positioned near a mid-sagittal plane of a face of the user, blocks the second field of view of the non-display eye.

displaying information to a user with a monocular display device adjustably positioned in front of a display eye of the user,

determining that the image is occupying a second field of view of a non-display eye of the user, and

in response to the determining , adjusting the monocular display device to display the information to a first field of view of the display eye, the first field of view being outside any field of view of the non-display eye.

adjusting the monocular display device comprises automatically re-positioning display of the image to the first field of view.

adjusting the monocular display device comprises manually re-positioning the monocular display device relative to a face of the user.

At least a portion of the functionality of the various elements in FIG. 4 through FIG. 14 may be performed by other elements in FIG. 15, or an entity (e.g., processor, web service, server, application program, computing device, etc.) not shown in any of FIG. 4 through FIG. 15.

In some examples, the operations illustrated in FIG. 14 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “BLUETOOTH” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special-purpose computing device when configured to execute the instructions described herein.

The examples illustrated and described herein as well as examples not specifically described herein but within the scope of aspects of the disclosure constitute exemplary means for a monocular display device that may be adjustably positioned in front of a display eye of a user to display an image in a first field of view of the display eye, and means for an occluder that may be adjustably positioned in front of a non-display eye of the user to block a second field of view of the non-display eye, where the second field of view corresponds to the first field of view. For example, the elements illustrated in FIGS. 4, 5, and 10-13 constitute these exemplary means. In another example, the elements illustrated in FIG. 15, such as when encoded to perform the operations illustrated in FIG. 14, constitute exemplary means for displaying information to a user with a monocular display device adjustably positioned in front of a display eye of the user, exemplary means for determining that the image is occupying a second field of view of a non-display eye of the user, and exemplary means for adjusting the monocular display device to display the information to a first field of view of the display eye, the first field of view being outside any field of view of the non-display eye.

Alternatively, or in addition, the functionalities described herein may be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip (SOCs) systems, programmable logic devices (PLDs), etc.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A system for eliminating binocular rivalry occurring from use of a monocular display device, said system comprising:
a monocular display device adjustably positioned in front of a display eye of a user, the monocular display device displaying information in a first field of view of the display eye; and
an occluder adjustably positioned in front of a non-display eye of the user, the occluder blocking a second field of view of the non-display eye, the second field of view corresponding to the first field of view.

2. The system of claim 1, wherein the occluder comprises a component attached to a part of the monocular display device, the component being located near a mid-sagittal plane of a face of the user and blocking the second field of view of the non-display eye.

3. The system of claim 2, wherein blocking the second field of view comprises limiting the second field of view of the non-display eye.

4. The system of claim 2, wherein the component is selected from a group consisting of a fin, a flap, a blade, a flipper, a vane, a sheet, and a tab.

5. The system of claim 1, wherein the occluder comprises a nose bridge component that extends outward from a nose of the user.

6. The system of claim 1, wherein the occluder comprises an attachable frame that is removably attached to the monocular display device.

7. The system of claim 1, wherein the occluder comprises an electrical occluder.

8. The system of claim 7, wherein a transmittance of the electrical occluder varies in response to application of a control signal.

9. The system of claim 7, wherein the electrical occluder comprises liquid crystal material.

10. The system of claim 7, wherein the electrical occluder comprises electrochromic material.

11. The system of claim 7, wherein the electrical occluder includes a set of slats fitted within a frame, the frame being located near a mid-sagittal plane of a face of the user, the slats being rotatable to block or unblock the second field of view of the non-display eye.

12. The system of claim 11, wherein the slats automatically rotate to block the second field of view of the non-display eye.

13. The system of claim 11, wherein the slats rotate in response to a command given by the user to block the second field of view of the non-display eye.

14. An apparatus for eliminating binocular rivalry occurring from use of a monocular display device displaying information in a first field of view of a display eye of a user, said apparatus comprising:
an occluder adjustably positioned in front of a non-display eye of the user, the occluder blocking a second field of view of the non-display eye, the second field of view corresponding to the first field of view of the display eye.

15. The apparatus of claim 14, wherein the occluder comprises a photochromic structure that automatically darkens in response to ambient light to limit the second field of view of the non-display eye.

16. The apparatus of claim 14, wherein the occluder comprises a hand held device that, when positioned near a mid-sagittal plane of a face of the user, blocks the second field of view of the non-display eye.

17. The apparatus of claim 14, wherein the occluder comprises an adjustable component worn on the body of the user that, when positioned near a mid-sagittal plane of a face of the user, blocks the second field of view of the non-display eye.

18. A method for eliminating binocular rivalry occurring from use of a monocular display device, said method comprising:
displaying information to a user with a monocular display device adjustably positioned in front of a display eye of the user;
determining that the image is occupying a second field of view of a non-display eye of the user; and
in response to the determining, adjusting the monocular display device to display the information to a first field of view of the display eye, the first field of view being outside any field of view of the non-display eye.

19. The method of claim 18, wherein adjusting the monocular display device comprises automatically or manually re-positioning display of the image to the first field of view.

20. The method of claim 18, wherein determining that the image is occupying a second field of view comprises receiving input from the user to adjust display of the image.
